(19) United States
(12) Patent Application Publication
(10) Pub. No.: US 2019/0139252 A1
(43) Pub. Date: May 9, 2019

(54) SYSTEMS AND METHODS FOR FOOTWEAR SIZING

(71) Applicant: SHOERETRIEVER, INC., Dover, DE (US)

(72) Inventors: Conrad P. Zaiss, Fair Oaks, CA (US); Zachary R. Zaiss, Fair Oaks, CA (US)

(21) Appl. No.: 16/110,725

(22) Filed: Aug. 23, 2018

Related U.S. Application Data
(60) Provisional application No. 62/550,516, filed on Aug. 25, 2017.

(51) Int. Cl. G06T 7/62; G06T 17/20; G06K 19/06

(52) U.S. Cl. CPC G06T 7/62; G06T 17/20; G06T 2207/30196; G06T 2207/30208; G06K 19/06028

(57) ABSTRACT

A method for determining a footwear size based on a 3D foot size is provided. The method may comprise: (a) providing a sock with multiple visual reference markers; (b) obtaining, with aid of a user device, an image data of a foot covered by the sock, wherein the image data comprises at least one of the multiple visual reference markers; (c) generating a 3D model of the foot using the image data; and (d) determining a footwear size based on the 3D model of the foot or one or more foot size parameters extracted from the 3D model of the foot.

### CROSS-REFERENCE

This application claims the benefit of U.S. Provisional Application No. 62/550,516, filed Aug. 25, 2017, which application is incorporated herein by reference.

### BACKGROUND

The correct fitting of footwear continues to be of interest in footwear and clothing retail. In particular, selecting the right size for footwear is a challenge during online shopping. When consumers buy or order footwear in a store or online, it's difficult to assess proper fit, particularly given the large selections available and without the ability to try on footwear in their specific everyday scenario. Even when consumers shop in a store and have the ability to try footwear on, the location and the limited time and experience may not identify poorly fitting footwear. In some situations, correct fitting of shoes is difficult to achieve with a high degree of confidence based solely on a notional shoes size. Footwear manufacturers often provide purchasers with a wide selection of styles of footwear from which to choose. The footwear is typically manufactured on footlasts that define the inside cavity of the footwear. With differently shaped and sized footlasts used to make footwear for purchasers having differently shaped feet, often footwear purchased of the correct designated size will not properly comfortably fit. The variation in sizes between feet and footlasts of the same designated sizes leads to large return rates when the customer can try on footwear and even greater returns when the customer cannot try on the footwear. Furthermore, because the sets of footlasts for respective styles vary greatly between styles as well, the selected style, selected designated size, and individual shaped feet do not provide a customer with certainty of procuring properly fitting footwear without trying on the shoes in the retail store to attempt to verify a proper fit prior to purchase.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### SUMMARY

In light of the above, it would be desirable to provide a method and system for determining a precise three-dimensional fitting of footwear and retrieve a best-fit footwear using the precision fitting method. Methods and systems of the present disclosure are provided for selecting footwear based on precision measure of foot. The method and system provide convenience and time efficiency when selecting footwear online.

In some aspects, a method for determining a footwear size based on a 3D foot size is provided. The method may comprise: (a) providing a sock with multiple visual reference markers; (b) obtaining, with aid of a user device, an image data of a foot covered by the sock, wherein the image data comprises at least one of the multiple visual reference markers; (c) generating a 3D model of the foot using the image data; and (d) determining a footwear size based on the 3D model of the foot or one or more foot size parameters extracted from the 3D model of the foot.

In some embodiments, at least one of the multiple visual reference markers is located around a toe portion, a heel portion, an instep portion, or a bottom/gusset portion of the foot when the sock is worn on the foot. In some embodiments, at least two of the multiple visual references markers are disposed on different portions or sides of the foot when the sock is worn on the foot. In some embodiments, the image data is obtained by performing a panorama scan of the foot. In some embodiments, the method further comprises determining whether obtaining the image data is completed in step (b). In some cases, obtaining the image data is determined to be completed when a pre-determined number or all of the multiple visual reference markers are contained in the image data. In some cases, a message is generated when obtaining the image data is determined to be not completed. For example, the message comprises information indicating which visual reference markers are not captured in the image data.

In some embodiments, the one or more foot size parameters are selected from the group consisting of foot width, foot length, foot height, ball length, ball girth, instep girth, heel width, instep height, and arch profile. In some embodiments, the method further comprises determining a footwear size based on the one or more foot size parameters, a footlast data and a fitting data. In some cases, the footwear size is determined by comparing the one or more foot size parameters with one or more footlast parameters, a style data and the fitting data. In some embodiments, the user device is a mobile device equipped with an imagine device. In some cases, the imaging device is an optical imaging device. In some embodiments, the sock further comprises a leg portion or cuff portion and at least one of the multiple visual reference markers is disposed at the leg portion or cuff portion. In some embodiments, each of the multiple visual reference markers comprises a unique graphical indicator. In some cases, the graphical indicator is a graphical barcode.

In some embodiments, a pre-known dimension of the multiple visual reference markers is used for generating the 3D model of the foot. In some embodiments, at least one of the multiple visual reference markers is composed of non-elastic material. In some embodiments, a subset of the multiple visual reference markers are disposed in a non-elastic region of the sock.

It shall be understood that different aspects of the invention can be appreciated individually, collectively, or in combination with each other. Various aspects of the invention described herein may be applied to any of the particular applications set forth below or for any other types of the footwear sizing system disclosed herein. Any description herein concerning the 3D foot size measurement may apply to and be used for any other footwear selection situations. Additionally, any embodiments disclosed in the context of the footwear size selection system are also applicable to the methods disclosed herein

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 shows exemplary foot size parameters, in accordance with embodiments of the invention.

FIG. 2 shows exemplary sock with one or more reference markers, in accordance with embodiments of the invention.

FIG. 2A shows an example of a wired frame of a 3D foot model formed with the plurality of reference markers

FIG. 3 shows an exemplary user device, in accordance with embodiments of the invention.

FIG. 4 illustrates an example of capturing image data of a foot covered by a sock.

FIG. 5 shows an image of the foot covered by an exemplary sock.

FIG. 6 schematically shows a system for determining a footwear size based on 3D foot parameters, in accordance with embodiments of the invention.

FIG. 7 shows examples of user foot size data and footlast data provided by footwear provider.

FIG. 8 schematically illustrates a process of obtaining a 3D foot size and determining a footwear size based on the 3d foot size.

FIG. 9 shows a computer system that can be configured to implement any computing system disclosed in the present application.

### DETAILED DESCRIPTION OF THE INVENTION

In the following detailed description, reference is made to the accompanying figures, which form a part hereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

Methods and systems of the present disclosure are provided for selecting footwear based on precision measure of foot. “Footwear” refers to any type of apparel that may be worn on a person's lower body, specifically the feet and optionally also the lower legs. Examples include athletic shoes, lace-up shoes, loafers, monks, skate shoes, school shoes, tap shoes, toe shoes and other shoes, work boots, ski boots, combat boots, fashion boots, hiking boots, thigh-length boots and other boots, sandals, slippers, flip-flops and other sandals, dress shoes, and any other apparel item designed to be worn on the foot and optionally also the lower leg. Footwear may refer to any items that at least partially cover the feet, such as ice skates, roller skates, roller blades, snow shoes or any other item. The footwear may be designed for adults (men, women) or children.

A size of footwear may fit differently for different individuals. Footwear of different styles may fit differently. Footwear made by different manufacturers may fit differently. In some instances, footwear made by different manufactures for the same style of shoes may have different sizes that fit an individual's feet. Optionally, footwear made by the same manufacturers for different styles of shoe may have different sizes that fit an individual's feet. Footwear manufacturers often provide purchasers with a wide selection of styles of footwear from which to choose. The footwear is typically manufactured on footlasts that define the inside cavity of the footwear. To provide a complete selection of various sizes from small to large sizes, in various lengths and widths, the manufactures uses a corresponding set of various sized footlasts to manufacture a style of footwear in ranges of sizes. The cavity of the footwear is a three dimensional cavity defined by the footwear footlasts. Because different footwear manufacturers use different footlasts for their respective styles and sizes, often a footlast of a designated size will be substantially different from the same designated size of a corresponding footlast of a different style. Even though the manufacturer may designate a size, that size, defined by the footlast cavity is not precise disadvantageously leading to nonconforming standard sized shoes incorrectly at times referenced to standard designated sizes. Additionally, the size and shape of human feet vary greatly from one human to another. Often, feet of the same standard size are substantially different in shape leading often to poorly fitting footwear of the same but presumed correct designated size.

Foot size of an individual may be measured in three dimensions using a user device. The individual may or may not be the user of the user device. Foot size may be determined from three-dimensional imaging of the foot covered by a sock with reference markers. A user may be guided by the reference markers during scanning of the foot. A plurality of foot size parameters or a three-dimensional foot model may be used to determine a best fitting size for a desired style of the footwear.

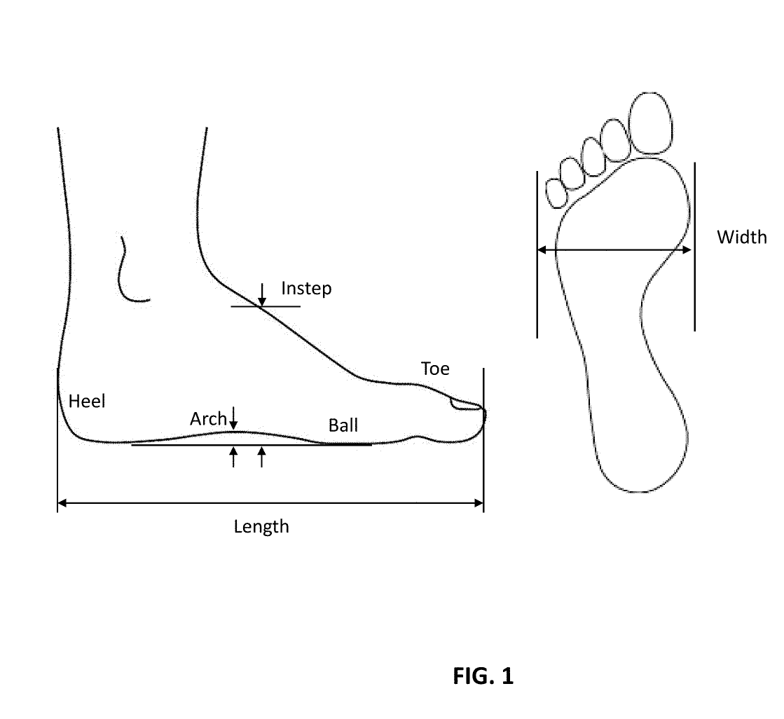

FIG. 1 shows exemplary foot size parameters, in accordance with embodiments of the invention. The foot size may be determined based on a three-dimensional measure of a foot. The foot size can be represented by a plurality of foot size parameters. A plurality of foot size parameters may collectively determine a foot in three dimensions. The foot size parameters may be measured in length such as millimeters or other length unit. The foot size parameters may comprise length, width and/or height of both feet, along with other foot measurement that include, but are not limited to, ball length (mm), ball girth (mm), instep girth (mm), heel width (mm), instep height (mm), and arch profile. In some cases, depending on the specific footwear such as boot with a long shaft, additional parameters such as circumference or width of the calf may also be measured. Any other foot size parameters may be used as long as a three-dimensional foot size can be determined. Width or height can be measured anywhere along length of the foot; length or height can be measured anywhere along width of the foot; width or length can be measured anywhere along height of the foot. In some cases, the foot size parameters can be any dimensions measured from a two-dimensional projection of a three-dimensional foot image. In some cases, the foot size parameters may be measured from a three-dimensional foot model in order to be compared with footlast provided by a footwear provider.

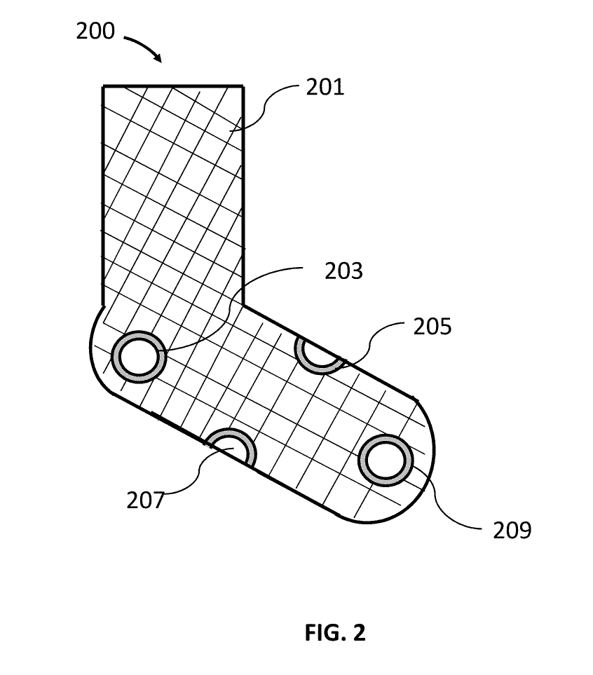

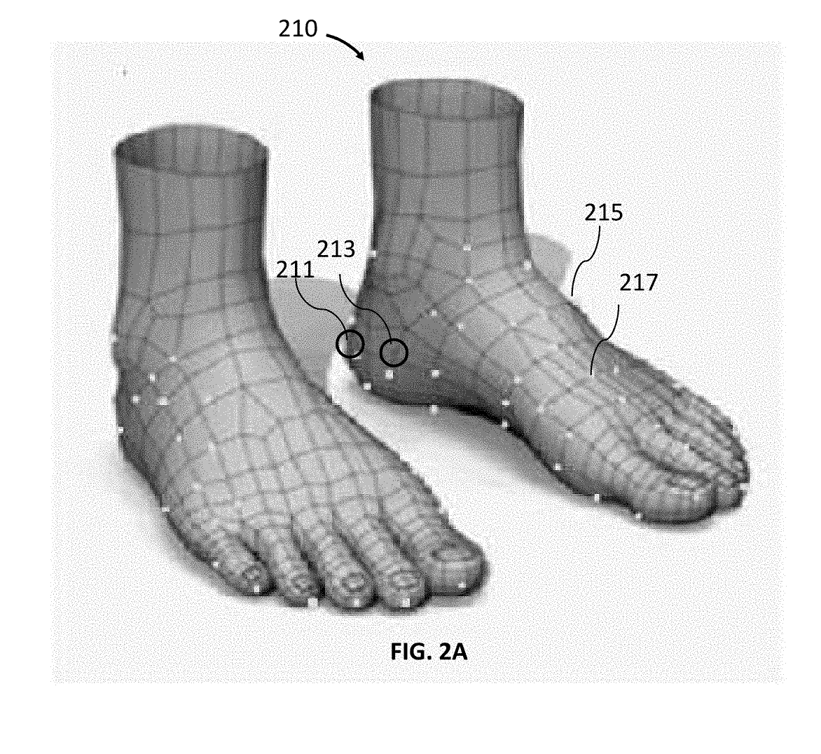

Foot may be imaged to obtain the plurality of foot size parameters. In some embodiments, a sock with one or more reference markers may be used to guide a user in capturing a three-dimensional image of the foot. FIG. 2 shows exemplary sock 200 with one or more reference markers, in accordance with embodiments of the invention. The sock 200 may comprise a main body 201 and one or more reference markers 203, 205, 207, 209. A sock is also known as a socklet, stocking or footcover.

The main body 201 of the sock may be constructed of woven material, non-woven material or a combination of both. For example, the main body of the material may be of natural or synthetic fibers. For instance, in some embodiments, the material may be a composition of cotton, spandex, nylon, and polyester. The material of the main body may also be of a composition that has some elasticity, so that it may accommodate the variety sizes of user's foot. Such elasticity also allows the sock to be easily put on and taken off. The sock may be stretchable such that the sock may accommodate all sizes of foot. The sock may be stretchable such that different sizes of the sock may accommodate different ranges of foot sizes. For instance, the sock may be stretchable to cover at least 3, 4, 5, 6, 7, 8, 9, 10, 11, 12, or more foot sizes.

In some cases, a portion of the sock may be non-stretchable or non-elastic whereas the remaining portion is elastic. For instance, a heel portion of the sock may be non-elastic or can be stretched by no more than 0.1%, 0.5%, 1%, 2%, 3%, 4%, 5%, 10%, 20%, 30%, 40%, or 50%. In some embodiments, a portion of the sock may be less stretchable than one or more other portions of the sock. The inelastic portion of the sock may be formed of a different material than one or more other portions of the sock. For instance, an inelastic portion of a sock may be formed from a less stretchable material or fiber than an elastic portion of the sock. Alternatively, the inelastic portion of the sock and elastic portion of the sock may be formed from a same material or fiber, but may have a different weave or structure. The inelastic portion of the sock may be provided at one or more locations on the sock. For example, the inelastic portion may be at or near a heel of the sock, a toe of the sock, an ankle area, a bottom of the sock, a side of the sock, an area of the sock over a top of the foot, or an area of a sock over a leg.

In some embodiments, the sock may be one-size-fit-all. Alternatively, multiple sock sizes may be provided to cover different ranges of sizes. The same sock may be provided for adult and children. Alternatively different sizes may be provided for adults and children. The sock 200 may have any thickness. In some cases, the sock may be thin sock. The sock can be disposable or be used repeatedly. The sock 200 may substantially cover the entire foot of a user or a portion of the foot. The sock may have a top extending to a wearer's ankle, lower leg, a portion of the calf, above the calf, above the knee, or above the thigh.

The sock 200 may comprise one or more reference markers 203, 205, 207, 209. The one or more reference markers may be used to guide a user scanning the foot covered by the sock. For example, a user may be prompted to scan the foot until all the markers are captured in the image data. Depending on the optical imaging techniques utilized for obtaining the 3D foot model, the reference markers may or may not be used as a reference to determine a size or dimension of the foot.

The sock 200 may comprise any number of reference markers. For example, at least one or more, two or more, three or more, four or more, five or more, six or more, seven or more, eight or more, nine or more, ten or more, fifteen or more, twenty or more reference markers may be included in a sock. In some cases, the number of reference markers may be associated with a size or dimension of the sock. For instance, when a sock with a top extending above the calf, more reference markers may be included compared to a sock having the top below the ankle. Alternatively, the number of reference markers may be the same across socks of different styles and/or sizes.

The one or more reference markers 203, 205, 207, 209 may be deployed in one or more locations in the main body of the sock. The one or more reference markers may be positioned so that when each of the reference markers is captured in an image, a 3D foot model may be generated. In some cases, at least one of the one or more reference markers is located around the toe 209, the heel portion 203 (e.g., heel flap, heel turn), the instep portion 205, or the bottom/gusset portion 207. In some cases, depending on the style of the sock, reference markers may be disposed around the leg portion or cuff portion in order to measure a dimension or profile of the calf. The plurality of the reference markers may or may not be distributed uniformly. The plurality of reference markers may cover substantially different sides of a foot (e.g., top side, bottom side, left side, right side, or back side). The plurality of reference markers may be located on at least two different sides of the foot such that when the reference markers are imaged a size of the foot in three-dimension may be captured. For example, at least one reference marker is located on a bottom side and at least one is located on a left/right side. In another example, at least one reference marker is located on the back side (e.g., heel flap) and at least one reference marker is located on the top side. In some cases, at least a reference marker is located around the leg/calf portion such that a dimension of the leg/calf is measured. In some cases, coordinates of the reference markers in 3D space may be obtained by processing the image data and the coordinates of the reference markers may be used to construct the 3D foot model. For instance, a plurality of reference markers may form a wired frame of a 3D foot model.

The one or more reference markers can be composed of any material that may or may not be woven. The one or more reference makers may be constructed from readily available plastic films, for example, vinyl (such as polyvinyl chloride), polyethylene, polypropylene, polycarbonate, polyester, silicon elastomer, acetate and so forth. The one or more reference markers may be constructed from any fabrics that may or may not be the same material of the main body of the sock.

The one or more reference markers may be part of the sock. The one or more reference markers may be woven into the sock and/or integral to the sock material. Alternatively, the one or more reference markers may be an additional element attached to the sock. The one or more reference markers may be formed as separate pieces then sewn, stitched, welded, taped, or adhered to the main body of the sock. Alternatively, the one or more reference markers may be formed with the main body of the sock as a single piece. For example, the reference markers may be painted, woven or marked using a different color to distinguish from the main body of the sock. The material of the reference marker may or may not be flexible or compliant. In some cases, the reference markers may conform to the profile of the foot.

The one or more reference markers may comprise any shapes and dimensions. For example, the one or more reference markers may have a shape such as circular, annular, rectangular, triangular, square, or any other irregular shapes. The one or more reference markers may have a dimension (e.g., length, width, height, diameter, diagonal) of at least 0.5 cm, 1 cm, 1.5 cm, 2 cm, 2.5 cm, 3 cm, 3.5 cm, or 4 cm. The one or more reference markers may or may not have a solid and continuous shape. For instance, the reference marker may have a through hole in the center.

The one or more reference markers may be detectable. The one or more reference markers may be detectable by optical sensors, thermal sensors or other imaging sensors. In some cases, the one or more reference markers may have a color that can be easily distinguished from the main body by eye or by optical sensors. A strong visual contrast may be provided between the reference markers and the rest of the sock. For instance, there may be a black/white contrast. The contrast may exist even if the sock is visualized in grayscale. There may be a variation in intensity or luminance of at least 5%, 10%, 25%, 50%, 75% or 90%. In some cases, the one or more reference markers may be detected by IR sensors and shown on a display of a user device. The one or more reference markers may be detectable within the visible spectrum, IR spectrum, UV spectrum and various other wavelength ranges.

In some cases, the one or more reference markers may be distributed in a universal fashion such that the left and right socks are interchangeable. In some cases, the one or more reference markers may be located around a circumference of a sock (e.g., tube sock) such that the sock needs not be aligned with the foot (e.g., heel to heel or top to top). The socks may be universal such that a user may not need to differentiate a left sock from a right sock. Alternatively, the left and right socks may comprise different distribution of reference markers (e.g., symmetrical distribution) such that the left sock and right sock can be distinguished from one another.

In some instances, the reference markers may be positioned relatively closely to one another. In some instances, some or all of the reference markers may be within 0.5 cm, 1 cm, 1.5 cm, 2 cm, 2.5 cm, 3 cm, 4 cm, 5 cm, or 6 cm of one another. In some instances, at least 2, 3, 4, 5, 6, 7, 8, 9, 10, or more reference markers may be within the distances described.

In some embodiments, a user may be guided to scan a foot covered by the sock with aid of the one or more reference markers. The one or more reference markers may be imaged and contained in the image data of the foot. An image of the foot with the sock on may be captured and a 3D model of the foot may be constructed based on the image data. A 3D size or dimension of the foot in world coordinate system may be obtained based on the image data. A plurality of foot size parameters as mentioned above can be extracted from the 3D model of the foot. The 3D model of the foot may comprise dimension of the foot in the world coordinate system with resolution of at least 5 mm, 4 mm, 3 mm, 2 mm, 1 mm, 0.5 mm, 0.1 mm or greater and the like. As mentioned before, in some cases, the reference markers may form a wired frame of the 3D foot model.

FIG. 2A shows an example of a wired frame of a 3D foot model 210 formed with the plurality of reference markers. In some embodiments, all the reference markers are made of the same material. For instance, all of the reference markers can be composed of elastic materials or non-elastic materials. In some cases, at least one of or a subset of the reference markers 211, 213 may be made of non-elastic materials such that a shape or dimension of the reference markers may remain. Alternatively or additionally, at least one of or a subset of the reference markers may be disposed at a non-elastic portion of the sock such that a shape or dimension of the reference markers may remain. The shape or dimension of such reference markers may then be used for accurately reconstructing the 3D model of the foot. A dimension of such a reference marker or distance between two or more of such reference markers may vary by less than 0.1%, 0.5%, 1%, 2%, 3%, 4%, 5%, 10%, 15%, or 20%. For instance, the dimension of the reference marker may be known or the distance between two reference markers disposed in the non-elastic portion of the sock is known, and such data may be used as reference for reconstructing the 3D model of the foot. Such non-elastic reference markers or reference markers in a non-elastic portion may be used as dimensional reference whereas the other reference markers may be used as guidance markers for scanning a foot. Alternatively, the non-elastic reference markers or reference markers in the non-elastic region may be used as both guidance markers for scanning a foot and a dimensional reference. Optionally, such markers may have a known orientation or positioning relative to one another. For example, a marker may have a shape that is radially asymmetrical, which may allow an orientation of a sock to be determined based on an orientation of a marker. In some instances, a relative positioning between such markers may allow for an orientation of a sock to be determined based on the locations of the markers.

In some instances, a sock may comprise one, two, three, four, five, six, or more reference markers on one or more relatively inelastic portions of the sock, or formed from relatively inelastic materials. Such reference markers may be referred to as inelastic reference markers (e.g., 211, 213). A sock may comprise one, two, three, four, five, six, seven, eight, nine, ten or more reference markers on one or more relatively elastic portions of the sock, or formed from relatively elastic materials. Such reference markers may be referred to as elastic reference markers (e.g., 215, 217). In some embodiments, more elastic reference markers may be provided compared to inelastic reference markers. In some embodiments, elastic reference markers may span a larger area than the inelastic reference markers. Inelastic reference markers may or may not have a different visual appearance compared to elastic reference markers. For example, they may be different shapes, sizes, colors, or textures. Inelastic reference markers may be distinguishable from elastic reference markers by a user device configured to obtain a 3D model of a foot. For example, the user device may comprise a camera (e.g., visual camera, infrared camera, etc.) that may capture an image of the sock that may allow for distinguishing between the inelastic reference markers and elastic reference markers. Optionally, a generated model, such as a wireframe model, may display the location of the markers. The displayed model may optionally show a visual distinction between inelastic reference markers and elastic reference markers.

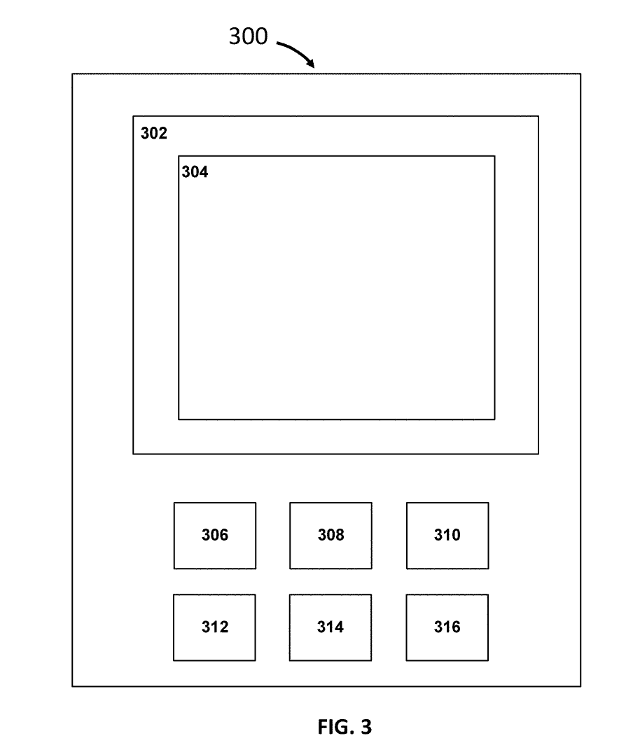

In some embodiments, a user device may be use to obtain the 3D model of the foot. The 3D model may be obtained from an image data of the foot captured by the user device. FIG. 3 shows an exemplary user device 300, in accordance with embodiments of the invention. The user device may be a device that includes a display 302, and may include an interface 304 for performing footwear purchase using the device. The user device may include one or more memory storage units 306, one or more processors 308, one or more communication units 310, one or more power source 312, one or more imaging device 314 and/or one or more sensors 116.

The user device 300 may be an electronic device capable of aiding in obtaining a 3D foot model of the user. The user device may be mobile device (e.g., smartphone, tablet, pager, personal digital assistant (PDA)), a computer (e.g., laptop computer, desktop computer, server, or any other type of device. The user device may optionally be portable. The user device may be handheld. The user device may be lightweight. In some embodiments, the user device may weigh 10, 8, 6, 5, 4, 3, 2, 1.5, 1, 0.7, 0.5, 0.3 0.1, 0.05, 0.01, 0.005, or 0.001 kg or less.

The user device may be a network device capable of connecting a network, such as a local area network (LAN), wide area network (WAN) such as the Internet, a telecommunications network, a data network, or any other type of network. The user device may be capable of direct or indirect wireless communications. The user device may be capable of peer-to-peer (P2P) communications and/or communications with cloud-based infrastructure.

The user device may be used during purchasing footwear or be used in various situations where an accurate foot size measurement is needed. In some cases, the user device may include determining and providing sizing information to a user for a specific footwear item in response to a user selection of the footwear item from a retailer, for example, an online retailer. The user device may be capable of communicating directly or indirectly with a footwear provider. The user device may be in communication with a server or an entity that is configured to process image data of the foot and generate foot size parameters/3D foot model. The user device may be in communication with a server or an entity that is configured to receive 3D foot model/3D foot size parameters and further utilize such data for various purposes. In some embodiments, the footwear provider may use or be a server or other type of online host. The user device may communicate with the server and/or other host device of the footwear provider entities. In some cases, the user device may aid in obtaining real-time user foot size information then provide a best fitting size in response to a user selection of footwear item from a retailer store. In some cases, accurate foot size information is obtained by the user device and can be used in various situations that may not be related to footwear purchase. For example, the user device may provide recommendations for footwear selection according to a footwear size and a fitting to the user's foot. The systems and methods provided herein may or may not be used directly in aid of footwear purchase. In some instances, the systems and methods provided herein may be standalone and independent of footwear purchase.

The user device may include a display 302. The display may show in real time one or more static images (e.g., photographs) and/or dynamic images (e.g., video) captured by an imaging device. The display may be able to present information to a user. The display may visually illustrate information. The information shown on the display may be changeable. The display may include a screen, such as a liquid crystal display (LCD) screen, light-emitting diode (LED) screen, organic light-emitting diode (OLED) screen, plasma screen, electronic ink (e-ink) screen, touchscreen, or any other type of screen or display. The display may or may not accept user input.

The display may show a graphical user interface 304. The graphical user interface may be part of a browser, software, or application that may aid in the user performing a transaction using the device. The interface may allow the user to view a 3D model of the user's foot or an image of the user's foot. The interface may provide information to guide the user scanning the foot properly with aid of the one or more reference markers as described above. The user may access a user account using the device. The user account may be used during a process of footwear purchase or providing a foot size. The user device may be capable of operating one or more software applications. One or more applications may or may not be related to a footwear purchase. One or more applications may require or use the imaging device.

The user device may be capable of accepting inputs via a user interactive device. Examples of such user interactive devices may include a keyboard, button, mouse, touchscreen, touchpad, joystick, trackball, camera, microphone, motion sensor, heat sensor, inertial sensor, or any other type of user interactive device.

The user device may comprise one or more memory storage units 306 which may comprise non-transitory computer readable medium comprising code, logic, or instructions for performing one or more steps. The user device may comprise one or more processors 308 capable of executing one or more steps, for instance in accordance with the non-transitory computer readable media. The one or more memory storage units may store one or more software applications or commands relating to the software applications. The one or more processors may, individually or collectively, execute steps of the software application.

A communication unit 310 may be provided on the user device. The communication unit may allow the user device to communicate with an external device. The external device may be a device of a footwear provider, server, or may be a cloud-based infrastructure. The external device can be another local device which is used to complete a footwear purchase such as a retailer device, a desktop and the like. The communications may include communications over a network or a direct communication. The communication unit may permit wireless or wired communications. Examples of wireless communications may include, but are not limited to WiFi, 3G, 4G, LTE, radiofrequency, Bluetooth, infrared, or any other type of communications.

The user device may have an on-board power source 112. Alternative, an external power source may provide power to power the user device. An external power source may provide power to the user device via a wired or wireless connection. An on-board power source may power an entirety of the user device, or one or more individual components of the wireless device. In some embodiments, multiple on-board power sources may be provided that may power different components of the user device. For instance, one or more sensor of the device may be powered using a separate source from one or more memory storage unit, processors, communication unit, and/or display of the device.

The user device may comprise an imaging sensor serves as imaging device 314. The imaging device 314 may be on-board the user device. The imaging device can include hardware and/or software element. In some embodiments, the imaging device may be a camera or imaging sensor operably coupled to the user device. In some alternative embodiments, the imaging device may be located external to the user device, and image data of a foot may be transmitted to the user device via communication means as described elsewhere herein. The imaging device can be controlled by an application/software configured to scan a foot. In some embodiments, the camera may be configured to scan a foot in 3D. In some embodiments, the software and/or applications may be configured to activate the camera on the user device to scan the foot. In other embodiments, the camera can be controlled by a processor natively embedded in the user device.

The imaging device 314 may be a fixed lens or auto focus lens camera. A camera can be a movie or video camera that captures dynamic image data (e.g., video). A camera can be a still camera that captures static images (e.g., photographs). A camera may capture both dynamic image data and static images. A camera may switch between capturing dynamic image data and static images. Although certain embodiments provided herein are described in the context of cameras, it shall be understood that the present disclosure can be applied to any suitable imaging device, and any description herein relating to cameras can also be applied to any suitable imaging device, and any description herein relating to cameras can also be applied to other types of imaging devices. The camera may comprise optical elements (e.g., lens, mirrors, filters, etc). The camera may capture color images, greyscale image, and the like.

The imaging device 314 may be a camera used to capture visual images of the foot. Any other type of sensor may be used, such as an infra-red sensor that may be used to capture thermal images of the foot. The imaging sensor may collect information anywhere along the electromagnetic spectrum, and may generate corresponding images accordingly.

In some embodiments, the imaging device may be capable of operation at a fairly high resolution. The imaging sensor may have a resolution of greater than or equal to about 100 μm, 50 μm, 10 μm, 5 μm, 2 μm, 1 μm, 0.5 μm, 0.1 μm, 0.05 μm, 0.01 μm, 0.005 μm, 0.001 μm, 0.0005 μm, or 0.0001 μm. The image sensor may be capable of collecting 4K or higher images.

The imaging device may capture an image frame or a sequence of image frames at a specific image resolution. In some embodiments, the image frame resolution may be defined by the number of pixels in a frame. In some embodiments, the image resolution may be greater than or equal to about 352×420 pixels, 480×320 pixels, 720×480 pixels, 1280×720 pixels, 1440×1080 pixels, 1920×1080 pixels, 2048×1080 pixels, 3840×2160 pixels, 4096×2160 pixels, 7680×4320 pixels, or 15360×8640 pixels.

The imaging device 314 may capture a sequence of image frames at a specific capture rate. In some embodiments, the sequence of images may be captured at a rate less than or equal to about one image every 0.0001 seconds, 0.0002 seconds, 0.0005 seconds, 0.001 seconds, 0.002 seconds, 0.005 seconds, 0.01 seconds, 0.02 seconds, 0.05 seconds. 0.1 seconds, 0.2 seconds, 0.5 seconds, 1 second, 2 seconds, 5 seconds, or 10 seconds. In some embodiments, the capture rate may change depending on user input and/or external conditions (e.g. illumination brightness).

The imaging device 314 may be configured to scan a foot to obtain image data. The imaging device may or may not be a 3D camera, stereo camera or depth camera. Various techniques can be used to obtain 3D model using imaging data. In some cases, the imaging device may be monocular camera and images of the foot taken from various angles may be used to reconstruct a 3D model of the foot. In some cases the imaging device may be a 3D camera. For example, a 3D camera having three components: a conventional camera, a near infrared image sensor and an infrared laser projector may be used. Infrared parts are used to calculate the distance between objects, but also to separate objects on different planes. The 3D camera lens has a built in IR cut filter. The 3D camera may be a video camera having a frame rate up to 60 fps with a 90° FOV, moreover its lens has an IR Band Pass filter. The IR laser integrates an infrared laser diode, low power class 1, and a resonant micro-minor. The 3D camera may utilize technology that is implemented in a depth sensor, stereo cameras, mobile devices, and any other device that may capture depth data. In some cases, depth sensing technologies use structured light or time of flight based sensing. For example, an infrared (hereinafter, also “IR”) emitter may project (e.g., emit or spray out) beams of infrared light into the foot with sock on. The projected beams of IR light may hit and reflect off objects that are located in their path (e.g., the foot and sock with reference markers). A depth sensor may capture (e.g., receive) spatial data about the surroundings of the depth sensor based on the reflected beams of IR light. In some example embodiments, the captured spatial data may be used to create (e.g., represent, model, or define) a 3D model of foot that is displayed on a display of the user device. The camera determines one or more measurements (e.g., dimensions) of the body of the user as part of the analysis of the image and the 3D foot model.

The user device may have one or more sensors 316 on-board the device to provide instantaneous positional and attitude information of the imaging device. In some cases, the one or more sensors such as IMU may also aid in obtaining a 3D image. In some embodiments, the positional and attitude information may be provided by sensors such as a location sensor (e.g., Global Positioning System (GPS)), inertial sensors (e.g., accelerometers, gyroscopes, inertial measurement units (IMUS)), altitude sensors, attitude sensors (e.g., compasses) pressure sensors (e.g., barometers), and/or field sensors (e.g., magnetometers, electromagnetic sensors) and the like.

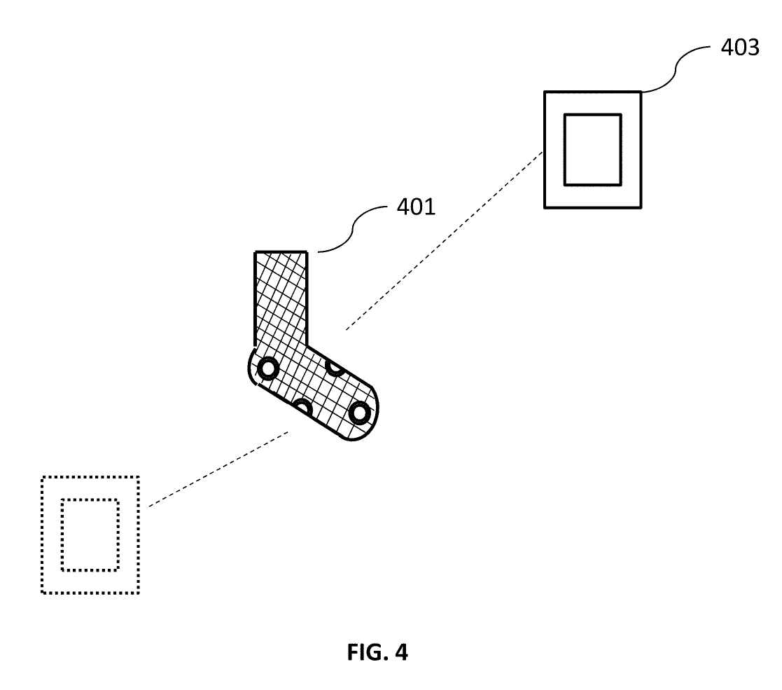

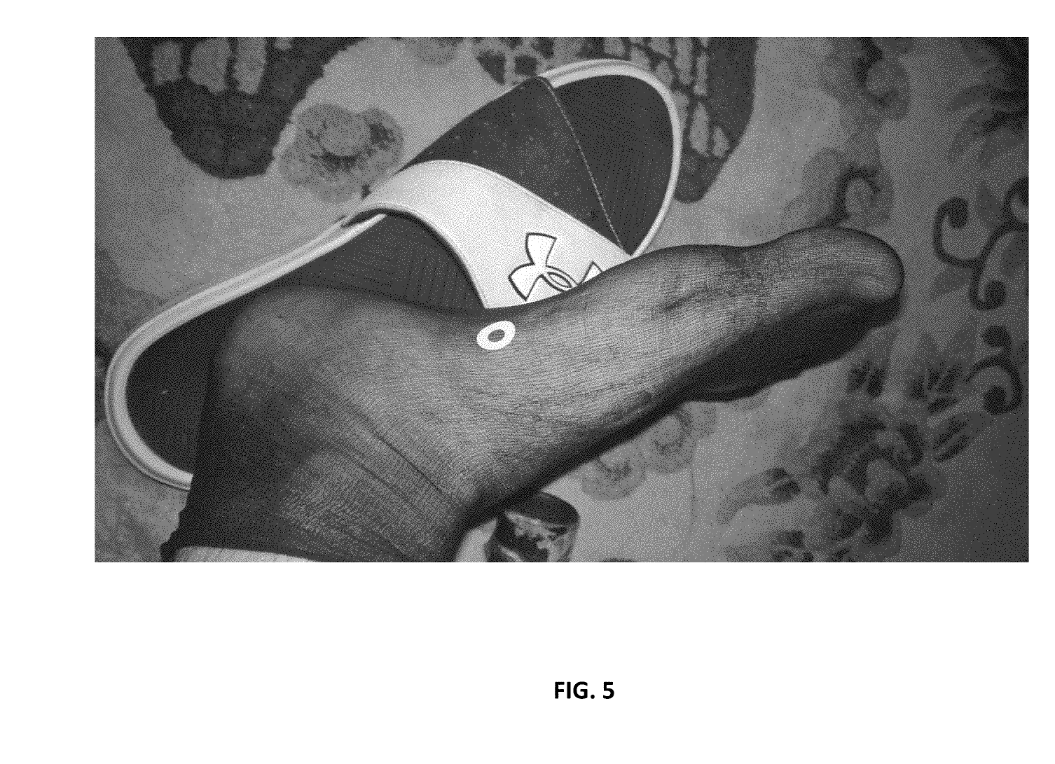

FIG. 4 and FIG. 5 illustrate an example of capturing image data of a foot covered by a sock 401. In some embodiments, the image data may comprise a plurality image frames captured from at least two different angles relative to the foot. As shown in FIG. 4, a user device 403 may point towards the foot from at least two different angles to capture at least two sides of the foot. In some cases, each of the reference markers needs to be captured in the image frame in order to generate a 3D foot model. In some cases, a continuous video scanning of the foot may be performed. Two or more image frames captured at different points in time or different locations may be processed to reconstruct a 3D foot model. A user may be prompted to capture two or more reference markers embedded in the sock. In some cases, the image data may comprise at least one reference marker as shown in FIG. 5. In some cases, the image data may comprise only one reference marker and a continuous video shooting of the foot may generate a video data used for constructing a 3D foot model. In such case, method such as optical flow analysis may be employed to reconstructing the 3D foot model.

A user may be guided to capture an image of the foot by capturing one or more of the reference markers located on the sock. In some cases, two or more image frames captured at different points in time or different locations may be processed to reconstruct a 3D foot model. For example, a user may perform a panorama scan of the foot by moving the camera user device surrounding the foot. In some cases, a user may be prompted to scan the foot until all of the reference markers are captured. For example, a user may be prompted to continue a scan until receive a scan complete message. A scan may be completed when all of the reference markers are captured. A scan may be completed when some of the reference markers are captured. A complete scan may indicate the captured image data is sufficient for generating a 3D model of the foot. A user may be allowed to capture the one or more reference markers in any sequence or order. In some cases, an indicator indicates a successful capturing of a reference marker may be displayed on the user device. In some cases, one or more reference markers remained to be scanned may be displayed on the user device and a user may be guided to scan the remaining reference markers accordingly. Guidance message may be provided to the user in various ways such as graphical elements, text message, audio message, vibration and the like.

The one or more reference markers may or may not be used as dimension reference for generating the 3D model. In some cases, the 3D model of the foot may be generated without using of the reference markers. In some cases, the 3D model of the foot may be generated based on a pre-known dimension of the reference markers. In some cases, the one or more reference markers may comprise a graphical indicator such that during scanning, it would be readily known which side/marker has been scanned. A graphical indicator may be uniquely associated with a reference marker or a side of the foot. The graphical indicator may be any graphical barcode such as two-dimensional barcode (e.g, Aztec, MaxiCode, and QR code, etc) or one-dimensional barcode (e.g., Interleaved 2/5, Industrial 2/5, Code 39, Code 39 Extended, Codabar, Code 11, Code 128, Code 128 Extended, EAN/UCC 128, UPC-E, UPC-A, EAN-8, EAN-13, Code 93, Code 93 Extended, DataBar Omnidirectional (RSS-14), DataBar Truncated (RSS-14 Truncated), DataBar Limited (RSS Limited), DataBar Stacked, DataBar Expanded, DataBar Expanded Stacked, etc). The graphical indicator may be any graphical element that can be recognized using image processing techniques such as pattern recognition techniques.

In some embodiments, upon completion of a scan, 3D model of the foot may be generated. The 3D model of the foot may then be analyzed and extracted for one or more foot size parameters as described elsewhere herein. The 3D model information from the user may be used to determine, based on the measurements of the 3D model, one or more sizes of fashion items from different brands (e.g., manufacturers or sellers of fashion items) that may fit the user's foot and/or leg portion. For example, the one or more foot size parameters may be used to determine a footwear size with respect to a specific footwear style and/or manufacturer.

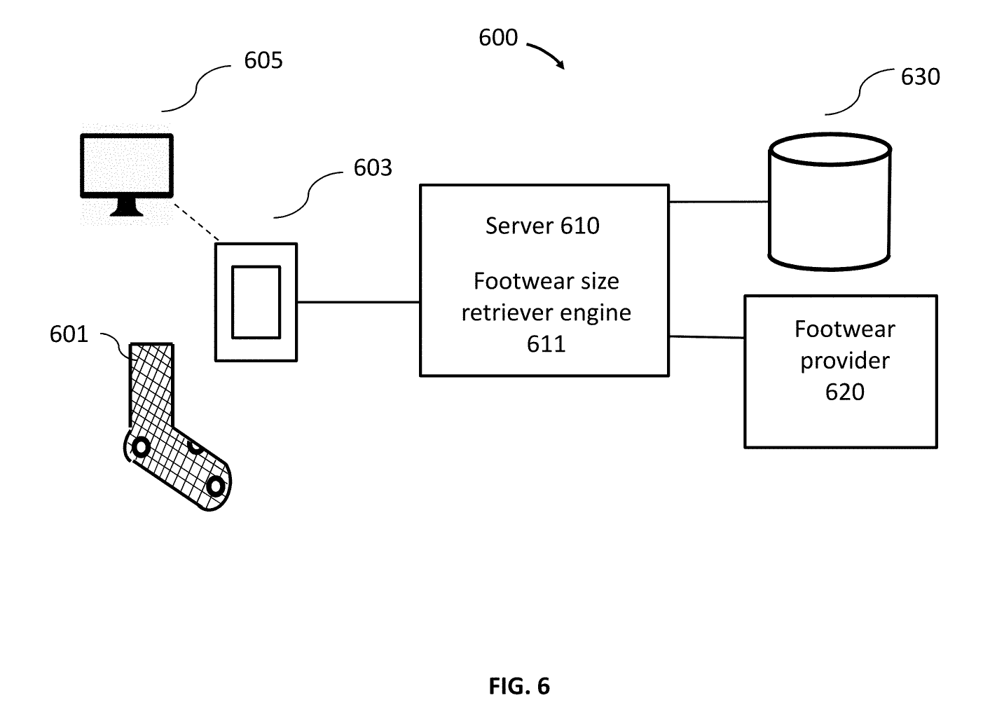

FIG. 6 schematically shows a system 600 for determining a footwear size based on 3D foot parameters, in accordance with embodiments of the invention. A user may be asked to provide a foot size in order to determine a footwear size provided by a footwear provider 620. The footwear provider 620 can be any entities that may provide a selection of footwear sizes to the user for selection. For example, the footwear provider may be a retailer, a manufacturer, a third-party online shopping entity, e-commerce systems, retail systems, merchant's systems, social networking platforms, and/or other entities which the user provides foot size to or is provided footwear related service with.

A user may be asked to put on a sock 601 with one or more reference markers then scan the foot with a user device 603. The user may be guided to scan the foot with aid of the one or more reference markers. A 3D foot model may be generated based on the captured image data. One or more foot size parameters in 3D may be measured from the 3D foot model. In some cases, after image data is captured by the user device, one or more foot size parameters may be measured locally on the user device then transmitted to a server 610 for various applications. In some cases, upon obtaining image data of the foot, a 3D foot model is generated on the user device and transmitted to the server 610. In some cases, upon obtaining image data by the user device, the image data of the foot may be transmitted to the server 610 then a 3D foot model or foot size parameters may be generated by the server using the image data. In some cases, the one or more foot size parameters may be calculated by a server 610. The 3D model and/or the one or more foot size parameters may be transmitted from the user device 603 to the server 610. In some cases, the user device 603 may be used to further perform transactions or footwear related services using the foot size parameters. In some cases, such services or transactions may be performed using another computing device 605. For instance, once a foot image is scanned by the user device, the foot image or a 3D foot model may be transmitted to the external computing device 605. The user may continue a footwear purchase using a browser, software, or application running on the computing device.

In some embodiments, the 3D model and/or the one or more foot size parameters may be stored in a database 630 for various other applications. The database 630 may be accessible by the user device 603, the computing device 605, the server 610 and/or the footwear provider.

In some embodiments, the server 610 may comprise a footwear size retriever engine 611 capable of determining a footwear size based on the user provided foot size parameters or 3D foot model. The footwear size retriever engine 611 may cross-reference the user ID to the 3D foot model or foot size parameters. Then the footwear size retriever engine may select among the sets of footlast data to automatically match the foot size data to the best footlast from a set of footlasts for the selected style and present the user with the best fit size. The footwear size retriever engine 611 may compare the one or more foot size parameters to a footlast data in order to determine a best fitting footwear size. In some cases, fitting data may also be requested in order to determine the best fitting footwear size. Alternatively, the 3D foot model may be used directly to determine a best fitting footwear size.

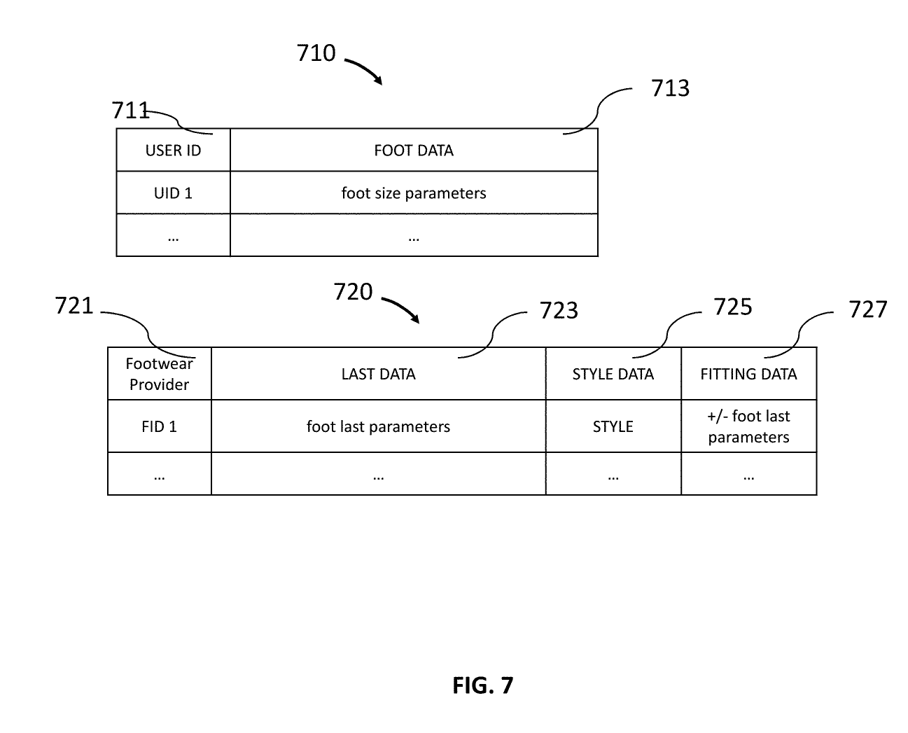

FIG. 7 shows examples of user foot size data 710 and footlast data 720. The footlast data 720 may be provided by a footwear provider (e.g., a retailer, a manufacturer, a third-party online shopping entity, e-commerce systems, retail systems, merchant's systems, social networking platforms and the like). In some embodiments, a foot size data 710 may be stored in a foot size database. The foot size data 710 may comprise a user ID 711 and one or more foot size parameters 713. The foot size parameters 713 may comprise, for example, length (m), width (mm), ball length (mm), ball girth (mm), instep girth (mm), heel width (mm), instep height (mm) and the like as described elsewhere herein. In some case, the foot size parameters may also comprise dimension of a portion of the leg such as the width of calf. The foot size parameters may be stored for the left foot and right foot respectively. In some cases, the foot size parameters may comprise the 3D model of the foot or the raw image data.

The user ID 711 may be uniquely associated with a user or a user account. A user can at any time provide the user ID and the desired style of a manufacturer. For example, a user may provide the user ID after imaging the foot and along with transmission of the 3D model, 3D image data or foot size parameters to the server.

Footlast data 720 may be provided by one or more footwear providers and stored in a footlast database. The footlast data 720 may have any data structure. The footlast data may be a 3D footlast model. The footlast data may have a particular data structure stores one or more footlast parameters. In alternative situations, a physical footlast may be provided. For instance, a physical footlast may be provided then 3D digital model of the footlast may be obtained from the physical footlast. In some embodiments, the footlast data may comprise a footwear provider ID 721, footlast parameter data 723, style data 725 and fitting data 727. The footwear provider ID 721 may cross-reference a respective manufacturer within a footwear provider database. In some cases, the footlast parameter data 723 may comprise the same data structure as the foot data 713. Alternatively, the footlast parameter data 723 may not comprise all of the foot size parameters as provided by the foot size data. In such case, a best fitting footwear size may be selected based on the available footlast data. For example, algorithms or functions may be used to determine a best fitting footwear size such as using data imputation. In some cases, the footlast parameter data 723 may comprise a 3D footlast model. Any dimensions can be determined from the 3D footlast model.

The footlast data may comprise style data 725. Different styles have different shapes that lead to different fits for the same designated size for the same pair of feet. Some areas of the foot and the corresponding locations within the cavity of the footwear are more critical than other locations depending on the style of footwear selected. For example, the width fit in stiff footwear, such as dress shoes, is more critical than the width fit in soft-shoes, such as comfort walking shoes. In some cases, the style may be selected by a user and cross-referenced within the footlast database to determine the best fitting footwear size.

In some embodiments, the footlast data may further comprise fitting data 727. In order to determine the best fitting footwear size, the fitting data is also preferably stored using a similar data structure referencing the same coordinate system. While there are many possible ways of determining the best fit, the preferred form uses +/− fit tolerances. The +/− tolerances provide a dimensional range. The tolerance can have various forms such as double sided (+/−) or single sided (+ or −). The two +/− tolerance values can be either positive for clearances or negative for interference. For example, the tolerance could be +15 mm and −5 mm, meaning that up to 15 mm of clearance to 5 mm of interference. Clearances provide comfort space between the foot and footwear whereas interference provides an overlapping fit between the foot and footwear, at the respective coordinate points within a zone. For example, up to 15 mm of toe clearance is desirable for stiff dress shoes but certainly not less than 6 mm. Some shoes stretch and use elastic type materials and conformable fits or stretching of the footwear material may require interference for the best fit. The +/− tolerance are used in ranges, both extremes of the range may be clearance positive values, may be two interference negative values or may be a clearance to an interference value. The +/− tolerances may or may not be completely defined. In some cases, a partial set of tolerance may be used for determining the fit to only a few critical conform zones about the foot. Various method or algorithms may be utilized to determine best fit size. In some cases, these algorithms may be specified by the manufacturer having expert knowledge of the manner by which their respective footwear tend to fit variously shaped and sized human feet. In some cases, cloud data may be analyzed and machine leaning algorithm may be used to generate a model to determine the best fit footlast. Various predetermined algorithms may be utilized. For instance, when a plurality of footlasts are within acceptable sizing range, the best fit footlast may be the next size up.

A best fit footlast data may be determined based on the foot size parameters, the footlast data and the fitting data. A variety of algorithms can be used to determine the best fit footlast data. For example, an algorithm may compare respective foot size parameters to respective footlast data combined with respective fitting tolerances all of which are cross referenced to each other for each coordinate point using the coordinate system. By way of example, the width is a critical comfort zone, may be imaged to be 130 mm, with the style selected has three footlasts, size C at 110 mm, size D at 120 mm and size Eat 130 mm in respectively C, D and E footlast for the desired footwear style. The tolerances for each C, D and E fitting are, in the exemplar form, the same for all three sizes, and are by way of example, +15 mm and −5 mm. The determination of an acceptable fit compares the 130 mm of the foot image to size C at 110 mm+15 mm/−5 mm, size D at 120 mm+15 mm/−5 mm and size E at 130 mm+15 mm/−5 mm. In the case of size C, the 130 mm foot image width is outside the acceptable range between of 125 mm and 105 mm. In the case of sized D and E, the 130 mm foot image width is within the 135 mm to 115 mm range and 145 mm to 125 mm range. Hence, size C is unacceptable and sizes E and D are acceptable. In this manner, comparing foot size parameters to ranges defined by the footlast data and fitting tolerances, each coordinate point can be compare to determine that all of the coordinate points are acceptable to determine if the footlast has an acceptable size.

In the case of determining that, for a given style, there is a plurality of acceptable sized footlasts, the process in further enhanced to determine which one of the acceptable sized footlast is the best footlast. As with the determination of an acceptable fit, the best-fit determination can be accomplished by any of a vast variety of algorithms. In an example, each coordinate point is assigned a zero or one coordinate value depending on whether the foot image dimension is less than or is greater than or equal to the footlast dimension. The coordinate fit value for each coordinate point is then multiplied by a respective weight, that may for example, be a value between one and ten providing respective fit products that are summed together into an overall fit value. The acceptable footlast providing the highest fit value is deemed to be the best fit value.

Alternatively, the 3D foot model may be compared to a 3D footlast model. The comparison is preferably done point by point in a coordinate system that offers great precision is specifying the extent of the fit. Alternatively, the 3D foot model and the 3D footlast model may be sampled or meshed in a variety of ways to determine a fit.

In some embodiments, a footwear size can be cross-referenced by the footwear provider ID and/or style data. For example, a notional shoes size may be determined based on the best fit footlast data. The footwear size can be in any suitable form depending on the form provided by the footwear provider.

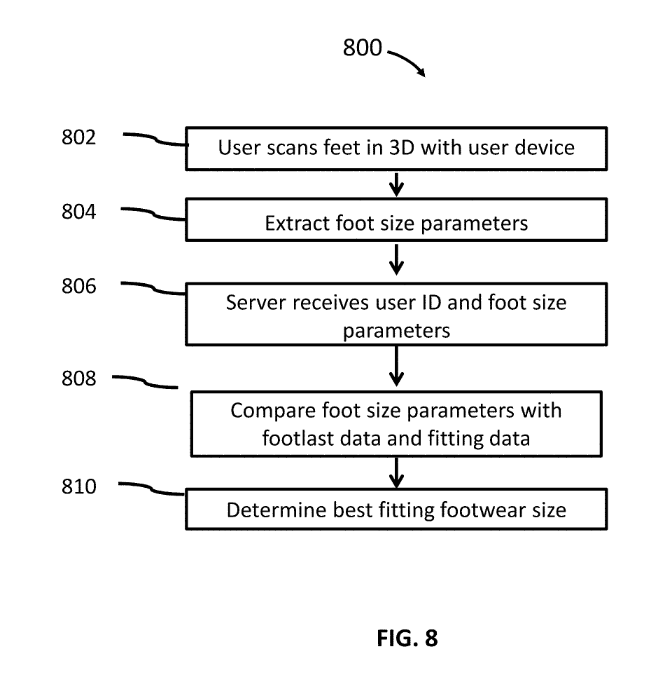

FIG. 8 schematically illustrates a process 800 of obtaining a 3D foot size and determining a footwear size based on the 3D foot size. A user may put on a sock with one or more reference markers prior to scanning the foot. The user may scan the foot with the sock using a user device 802. The captured image data may then be processed to generate a 3D foot model. The 3D foot model may be generated at the local user device or at a remote server as described above. One or more foot size parameters may be obtained based on the 3D foot model 804. In some cases, the one or more foot size parameters may also comprise the 3D foot model. Next, a user ID and the one or more foot size parameters may be received by the server 806. In some embodiments, in addition to the user ID and foot size parameters, user selected footwear brands, manufacturers, footwear providers, styles may also be transmitted to the server. The server can be the same server 610 as described in FIG. 6. The server may be configured to compare the one or more foot size parameters to a footlast data and fitting data 808. In some cases, the footlast data and fitting data may be provided by a footwear provider and stored in a footlast database. A best fitting footlast data may be determined using suitable algorithms as described elsewhere herein.

In some situations, a best fitting footwear size may be determined according to the selected best fitting footlast data 810 cross-referenced by the associated footwear provider ID and style data. In some situations, one or more footwear of different styles may be determined according to the selected best fitting footlast data. In some situations, one or more footwear of different brands or made by different manufacturers may be determined based on the best fitting footlast data. In some situations, the footwear sizes may be determined based on user input information. For instance, a user input information may comprise a user interested brand, manufacturer, style, or gender and the like such that the a best fitting footwear size may be provided based on these user input information. In one example, a user may specify a brand and model of shoe. The systems and methods provided herein may return the proper sizing for the user for that brand and model of shoe. In another example, a user may specify a shoe style (e.g., ‘running shoe’) and the systems and methods provided herein may provide proper sizing for various brands and models of that style of shoe. In another example, a user may make no specifications and the systems and methods provided herein may provide proper sizing for a variety of brands and models for multiple styles of shoe.

Although FIG. 8 shows a method in accordance with some embodiments a person of ordinary skill in the art will recognize many adaptations for variations. For example, the steps can be performed in any order. Some of the steps may be deleted, some of the steps repeated, and some of the steps may comprise sub-steps of other steps. The method may also be modified in accordance with other aspects of the disclosure as provided herein.

One or more processors may be configured with instructions for perform one or more steps illustrated in FIG. 8 and operations as described elsewhere herein.

The processor may be a hardware processor such as a central processing unit (CPU), a graphic processing unit (GPU), or a general-purpose processing unit. The processor can be any suitable integrated circuits, such as computing platforms or microprocessors, logic devices and the like. Although the disclosure is described with reference to a processor, other types of integrated circuits and logic devices are also applicable. The processors or machines may not be limited by the data operation capabilities. The processors or machines may perform 512 bit, 256 bit, 128 bit, 64 bit, 32 bit, or 16 bit data operations.

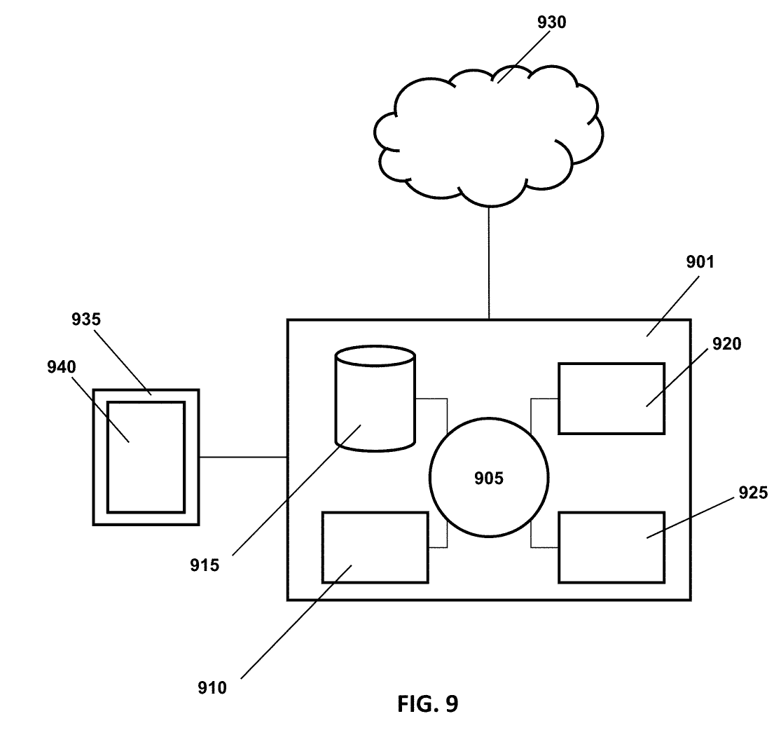

In some embodiments, the processor may be a processing unit of a computer system. FIG. 9 shows a computer system 901 that can be configured to implement any computing system disclosed in the present application. The computer system 901 can comprise a mobile phone, a tablet, a wearable device, a laptop computer, a desktop computer, a central server, etc.

The computer system 901 includes a central processing unit (CPU, also “processor” and “computer processor” herein) 905, which can be a single core or multi core processor, or a plurality of processors for parallel processing. The CPU can be the processor as described above. The computer system 901 also includes memory or memory location 910 (e.g., random-access memory, read-only memory, flash memory), electronic storage unit 915 (e.g., hard disk), communication interface 920 (e.g., network adapter) for communicating with one or more other systems, and peripheral devices 925, such as cache, other memory, data storage and/or electronic display adapters. In some cases, the communication interface may allow the computer to be in communication with another device such as the imaging device or audio device. The computer may be able to receive input data from the coupled devices for analysis. The memory 910, storage unit 915, interface 920 and peripheral devices 925 are in communication with the CPU 905 through a communication bus (solid lines), such as a motherboard. The storage unit 915 can be a data storage unit (or data repository) for storing data. The computer system 901 can be operatively coupled to a computer network (“network”) 930 with the aid of the communication interface 920. The network 930 can be the Internet, an internet and/or extranet, or an intranet and/or extranet that is in communication with the Internet. The network 930 in some cases is a telecommunication and/or data network. The network 930 can include one or more computer servers, which can enable distributed computing, such as cloud computing. The network 930, in some cases with the aid of the computer system 901, can implement a peer-to-peer network, which may enable devices coupled to the computer system 901 to behave as a client or a server.

The CPU 905 can execute a sequence of machine-readable instructions, which can be embodied in a program or software. The instructions may be stored in a memory location, such as the memory 910. The instructions can be directed to the CPU 905, which can subsequently program or otherwise configure the CPU 905 to implement methods of the present disclosure. Examples of operations performed by the CPU 905 can include fetch, decode, execute, and writeback.

The CPU 905 can be part of a circuit, such as an integrated circuit. One or more other components of the system 901 can be included in the circuit. In some cases, the circuit is an application specific integrated circuit (ASIC).

The storage unit 915 can store files, such as drivers, libraries and saved programs. The storage unit 915 can store user data, e.g., user preferences and user programs. The computer system 901 in some cases can include one or more additional data storage units that are external to the computer system 901, such as located on a remote server that is in communication with the computer system 901 through an intranet or the Internet.

The computer system 901 can communicate with one or more remote computer systems through the network 930. For instance, the computer system 901 can communicate with a remote computer system of a user. Examples of remote computer systems include personal computers, slate or tablet PC's, smart phones, personal digital assistants, and so on. The user can access the computer system 901 via the network 930.

Methods as described herein can be implemented by way of machine (e.g., computer processor) executable code stored on an electronic storage location of the computer system 901, such as, for example, on the memory 910 or electronic storage unit 915. The machine executable or machine readable code can be provided in the form of software. During use, the code can be executed by the processor 905. In some cases, the code can be retrieved from the storage unit 915 and stored on the memory 910 for ready access by the processor 905. In some situations, the electronic storage unit 915 can be precluded, and machine-executable instructions are stored on memory 910.

The code can be pre-compiled and configured for use with a machine having a processer adapted to execute the code, or can be compiled during runtime. The code can be supplied in a programming language that can be selected to enable the code to execute in a pre-compiled or as-compiled fashion.

Aspects of the systems and methods provided herein, such as the computer system 901, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 901 can include or be in communication with an electronic display 935 that comprises a user interface 940 for providing, for example, a scanning interface or a footwear purchase interface. Examples of UI's include, without limitation, a graphical user interface (GUI) and web-based user interface. The user interface 940 may be the same as the user interface as described in FIG. 3. Alternatively, the user interface may be a separate user interface.

Methods and systems of the present disclosure can be implemented by way of one or more algorithms. An algorithm can be implemented by way of software upon execution by the central processing unit 905.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

1. A method for determining a footwear size based on a 3D foot size comprising:
(a) providing a sock with multiple visual reference markers;
(b) obtaining, with aid of a user device, an image data of a foot covered by the sock, wherein the image data comprises at least one of the multiple visual reference markers;
(c) generating a 3D model of the foot using the image data; and
(d) determining a footwear size based on the 3D model of the foot or one or more foot size parameters extracted from the 3D model of the foot.

2. The method of claim 1, wherein at least one of the multiple visual reference markers is located around a toe portion, a heel portion, an instep portion, or a bottom/gusset portion of the foot when the sock is worn on the foot.

3. The method of claim 1, wherein at least two of the multiple visual references markers are disposed on different portions or sides of the foot when the sock is worn on the foot.

4. The method of claim 1, wherein the image data comprises a plurality of images captured from different sides of the foot.

5. The method of claim 1, wherein the image data is obtained by performing a panorama scan of the foot.

6. The method of claim 1, further comprising determining whether obtaining the image data is completed in (b).

7. The method of claim 6, wherein obtaining the image data is determined to be completed when a pre-determined number or all of the multiple visual reference markers are contained in the image data.

8. The method of claim of claim 6, further comprising generating a message when obtaining the image data is determined to be not completed.

9. The method of claim 8, wherein the message comprises information indicating which visual reference markers are not captured in the image data.

10. The method of claim 1, wherein the one or more foot size parameters are selected from the group consisting of foot width, foot length, foot height, ball length, ball girth, instep girth, heel width, instep height, and arch profile.

11. The method of claim 1, further comprising determining a footwear size based on the one or more foot size parameters, a footlast data and a fitting data.

12. The method of claim 11, wherein the footwear size is determined by comparing the one or more foot size parameters with one or more footlast parameters, a style data and the fitting data.

13. The method of claim 1, wherein the user device is a mobile device equipped with an imagine device.

14. The method of claim 13, wherein the imaging device is an optical imaging device.

15. The method of claim 1, wherein the sock further comprises a leg portion or cuff portion and at least one of the multiple visual reference markers is disposed at the leg portion or cuff portion.

16. The method of claim 1, wherein each of the multiple visual reference markers comprises a unique graphical indicator.

17. The method of claim 16, wherein the graphical indicator is a graphical barcode.

18. The method of claim 1, wherein a pre-known dimension of the multiple visual reference markers is used for generating the 3D model of the foot.

19. The method of claim 1, wherein at least one of the multiple visual reference markers is composed of non-elastic material.

20. The method of claim 1, wherein a subset of the multiple visual reference markers are disposed in a non-elastic region of the sock.
